(19) United States
(12) Patent Application Publication
(10) Pub. No.: US 2002/0023112 A1
(43) Pub. Date: Feb. 21, 2002

(54) Graphical web page editor

(75) Inventor: Lonny Avital, Teaneck, NJ (US)

Correspondence Address: Charles N.J. Ruggiero, Esq., Ohlandt, Greeley, Ruggiero & Perle, L.L.P., 10th Floor, One Landmark Square, Stamford, CT, 06901-2682, US

(73) Assignee: NTTX CORPORATION

(21) Appl. No.: 09/863,771

(22) Filed: May 23, 2001

Related U.S. Application Data
(60) Provisional application No. 60/206,616, filed on May 24, 2000.

(51) Int. Cl. G06F 15/00; G06F 17/24

(52) U.S. Cl. 707/513

(57) ABSTRACT

This invention is directed toward a method for editing web pages. The method includes retrieving the source code defining a web page, identifying insertion points in the source code and displaying them to a user in a graphical format. The method also includes allowing a user to insert a script into the source code by selecting a particular insertion point, and incorporating the script into the source code to produce an updated web page. The method also includes displaying the updated web page to the user, uploading the updated web page to an internet host, and directing the user to the uploaded, updated web page.

### BACKGROUND OF THE INVENTION

1. Field of the Invention

The invention relates to web page construction and in particular to editing web pages.

2. Description of the Prior Art

Web pages are usually defined, or constructed, using Hyper Text Markup Language (“HTML”). While HTML is very general and powerful, it is not structured and requires many lines of “code” to define simple visual layouts. A complex web page with many formatted components can easily grow to thousands of lines of code in a single module. This can make customization of a web page a daunting task for a novice web page designer.

To aid web page designers, there are many content providers, accessible through the Internet, and conventional means, who's main business is to provide “canned” scripts. These scripts are constructed of modular groups of code that are intended to be inserted into the HTML code of a web page. Examples of such scripts include icons of buttons, pictures, graphics, etc. and may further include functionality for these icons. For example, a script may include code that causes an animated picture to be displayed and to call a “shopping cart” function if a user clicks on the picture. Within the limitations of today's technology, these providers supply these “scripts,” as short, self contained paragraphs of code, usually written in HTML or JavaScript. A user can copy and insert the script in the appropriate place in the HTML code that describes a particular web page.

One problem with this approach is that it requires the web page designer to examine the HTML code of the web page, analyze it, and modify it to include the script in the right place. The multitude of novice web page designers who are new to web page design typically use programs that allow them to construct web pages without having any knowledge of the underlying technology. Many of these programs operate like word processors, allowing a user to construct an adequately functional web page without having knowledge of HTML coding techniques. Thus, for this group of novice web page designers, analyzing, modifying, and pasting code to include a script within a web page is not a practical solution. Modifying a simple web page would be a challenge for these types of users and modifying a page with moderate visual richness could be very difficult.

### SUMMARY OF THE INVENTION

An object and advantage of this invention is to provide a program that solves the problems described above by allowing a web user to insert scripts anywhere on a web page with a single click.

It is another object and advantage of the invention to present the user with an analyzed graphical display of the web page they wish to modify. The analyzed display shows graphical buttons at every valid insert point. By clicking on a button at the desired position, a user causes the page to be reconstructed with additional script content, selected by the user, in the elected position.

It is a further object and advantage of this invention to coordinate the transfer of web pages to be modified to and from the host site. The present invention is designed to support most web page providers and can be extended to add specific connection scripts for a particular host.

These and other objects and advantages of the present invention are realized by a method for editing web pages. The method includes retrieving the source code defining a web page, identifying insertion points in the source code and displaying them to a user in a graphical format. The method further includes allowing a user to insert a script into the source code by selecting a particular insertion point, and incorporating the script into the source code to produce an updated web page. The method also includes displaying the updated web page to the user, uploading the updated web page to an internet host, and directing the user to the uploaded, updated web page.

### BRIEF DESCRIPTION OF THE DRAWINGS

The above set forth and other features of the invention are made more apparent in the ensuing Detailed Description of the Invention when read in conjunction with the attached Drawings

FIG. 1 shows a flow diagram in accordance with the teachings of this invention;

FIG. 2 shows a graphical representation of a script to be inserted into a web page;

FIG. 3 shows a screen for specifying a web page to be edited;

FIG. 4 shows a web page with buttons showing each available insertion point;

FIG. 5 shows the script, inserted into the web page;

FIG. 6 shows a dialogue screen for specifying upload parameters; and

FIG. 7 shows the new, uploaded web page, updated with the script.

### DETAILED DESCRIPTION OF THE INVENTION

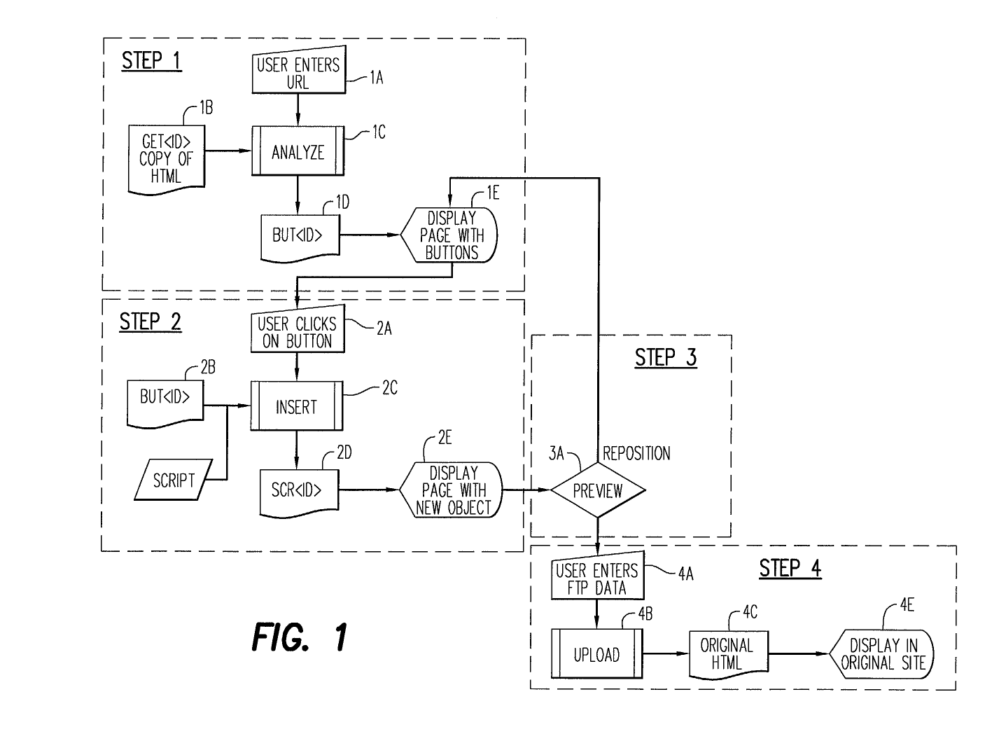

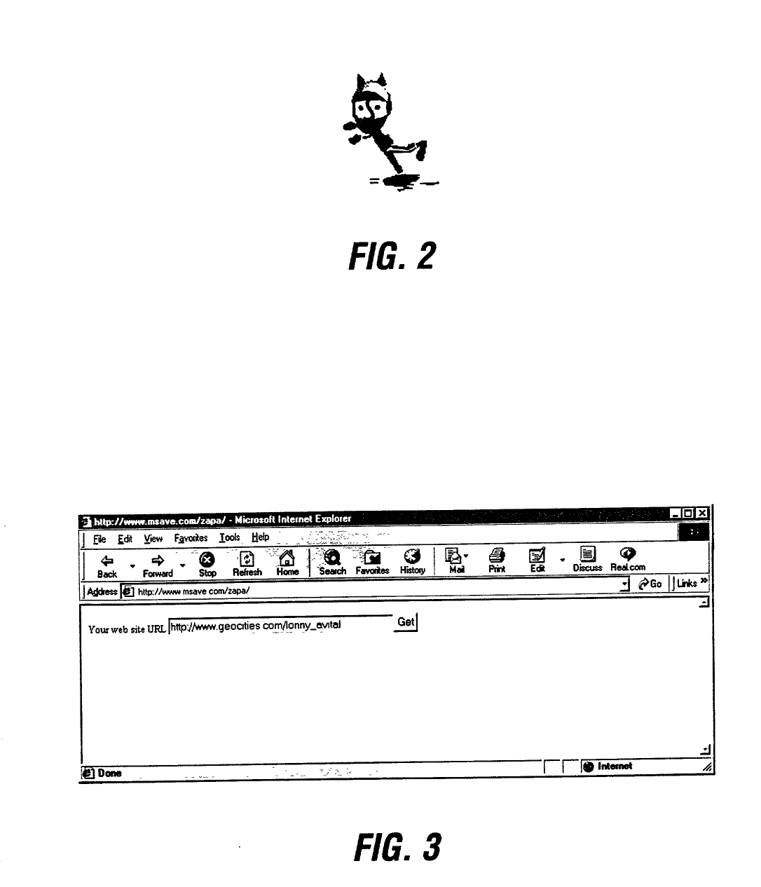

Referring to the figures and, in particular, FIG. 1, there is shown a flow diagram in accordance with the teachings of this invention. FIG. 2 shows a graphical result of a script to be inserted into a web page. In step 1A of FIG. 1, the user enters the URL of the web page to be edited. An example of a display for allowing a user to enter the desired URL is shown in FIG. 3.

Returning to FIG. 1, the program retrieves all the code that the site, designated by the URL, is constructed from, and performs the following tasks. In step 1B, the program saves the HTML in a file named “get<ID>” where ID represents a random identification number. In step 1C, the program analyzes the retrieved code.

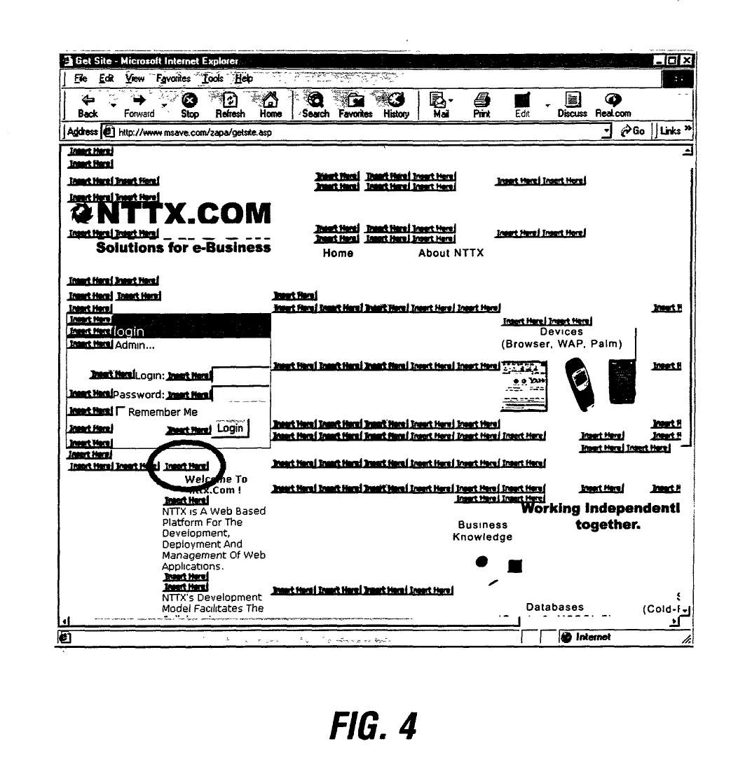

The analysis process begins by disabling all links so the user will not inadvertently click out of the process. The program then replaces all relative paths with actual paths so the images will show correctly. For example, the program may change statements such as “<img src=go.gif . . . ” to “<img src=http://www.site.com/go.gif.” The program then adds a graphical representation, for example, a button, as a linked image, at places in the code where insertion is possible. For example, the program may add a button before every image (“<IMG” tag), before every break (“<BR>” tag) and after every table cell (“<TD” tag). The program looks for the closing “>” in the “TD” case in order to put the button after the tag. Every button carries a button number (“POS,” typically a running number) and the ID number from the saved “get” HTML file. In code, a link will look like “<a href=setpos.cfm?pos=5&ID=327321>.” After the analysis, in step ID, the program then saves the new file with the name “but<ID>.” In step 1E, the program causes the web page, represented by the HTML code, with the buttons showing each available insertion point, to be displayed. FIG. 4 is an example screen of a web page with the buttons showing each available insertion point.

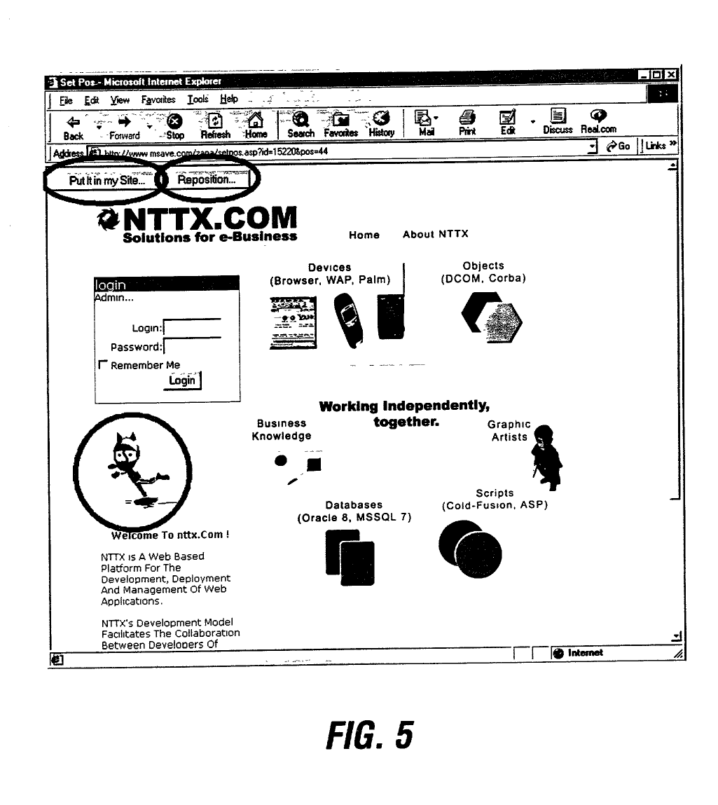

Proceeding to step 2A in FIG. 1, the user selects a position for the item by clicking on a particular button. In step 2B the program then searches the “get<ID>” file for the position number with the provided “POS.” As shown in step 2C, the program then inserts the script, composed of HTML code or JavaScript, into the right position, and in step 2D, saves the result in a file named “scr<ID>.” The program then causes the page to be displayed with the inserted script, as shown in step 2E. FIG. 5 shows the web page with the script inserted.

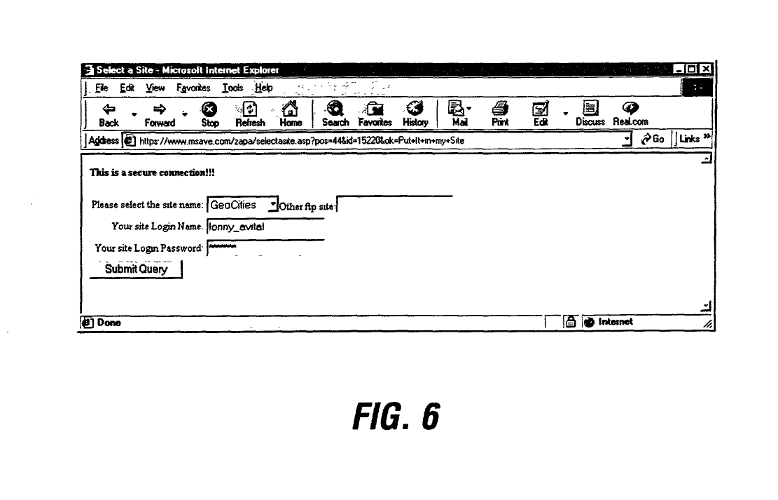

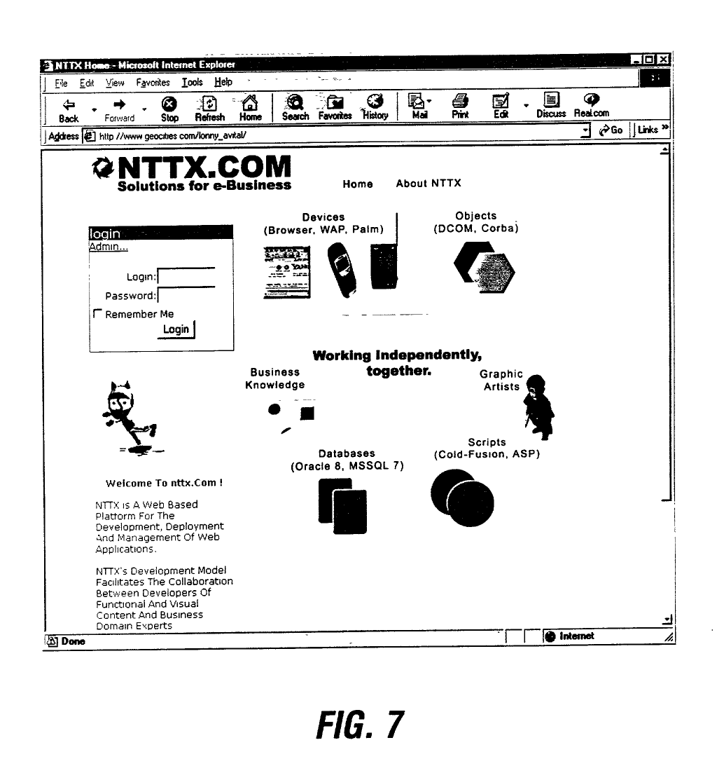

Returning to FIG. 1, the user then views the new page in step 3A. At this point, the user may decide to reposition the script or may upload the new page to the web page host. If the user decides to reposition the script, the program will perform a browser “BACK” and return to step 1E, allowing a user to reposition the script. As shown in step 4A, if the user decides to upload the new page to the web page host, the program prompts the user for information required to upload the new HTML file to the user desired location. The program prompts the user for the website host or ftp (File Transfer Protocol) server, the user login and password, and for the file name to upload. A screen for providing the information is shown in FIG. 6. Returning to FIG. 1, the user provides the upload information and then signals the program, for example by clicking on a button, to upload the new web page.

The program then connects to the specified location and uploads the information, as shown instep 4C, and then transfers the user to the site to view the changes, as shown in step 4D. FIG. 7 shows the new, uploaded web page, updated with the script.

It should be understood that while the present invention has been described in the context of displaying a button at each available insertion point in the code, the present invention is not limited to utilizing buttons to represent possible insertion points and may utilize any graphical representation to designate insertion points.

It should also be understood that while the present invention has been described in the context of inserting scripts, the present invention may be utilized to insert any encapsulated or modular code that is transportable or able to be inserted as described above.

It should be further understood that while the present invention has been described in the context of editing HTML code used for constructing web pages, the present invention is not limited to editing HTML code. The present invention may be used to edit any programming language that is capable of being analyzed for identification of insertion points as described above.

Thus, while the present invention has been particularly shown and described with respect to preferred embodiments thereof, it will be understood by those skilled in the art that changes in form and details may be made therein without departing from the scope and spirit of the invention.

Wherefore I claim:

1. A method for editing web pages comprising the steps of:
retrieving the source code defining a web page;
identifying insertion points in said source code; and
displaying said insertion points in a graphical format.

2. The method of claim 1, further comprising, after the step of displaying said insertion points:
inserting a script into said source code by selecting a particular insertion point;
incorporating said script into said source code to produce an updated web page; and
displaying said updated web page.

3. The method of claim 2, further comprising, after the step of displaying said updated web page:
uploading said updated web page to an internet host; and
directing a user to said uploaded, updated web page.

4. A method for editing source code comprising the steps of:
entering a location of said source code to be edited;
retrieving said source code;
analyzing said source code for insertion points;
displaying a graphical representation of said source code showing said insertion points;
selecting at least one of said insertion points;
inserting additional modular source code at said insertion point to produce updated source code;
displaying a graphical representation of said updated source code showing said additional modular source code;
uploading said updated source code to a desired location; and
directing a user to said desired location.

5. The method of claim 4, wherein said step of analyzing further comprises: disabling all links;
replacing all relative paths with actual paths; and
adding a graphical representation of at least one of said insertion points;

6. The method of claim 5, wherein said step of selecting comprises clicking on said graphical representation.
